(19) United States
(12) Patent Application Publication
(10) Pub. No.: US 2010/0194093 A1
(43) Pub. Date: Aug. 5, 2010

(54) SECURITY DEVICES, THEIR PRODUCTION AND USE

(75) Inventor: Charlie MACPHERSON, Santa Barbara, CA (US)

Correspondence Address: KIRBY EADES GALE BAKER, BOX 3432, STATION D, OTTAWA, ON, K1P 6N9, CA

(73) Assignee: BANK OF CANADA, Ottawa (CA)

(21) Appl. No.: 12/646,308

(22) Filed: Dec. 23, 2009

(51) Int. Cl. B42D 15/00; B32B 37/00; B32B 38/00; B05D 1/32

(52) U.S. Cl. 283/94; 156/60; 156/280; 427/282

(57) ABSTRACT

Security documents, such as passports, bank notes and credit cards, often incorporate security devices that are difficult to replicate by conventional printing or copying techniques. Disclosed herein are security devices and methods for their production. In selected embodiments, the security devices may be used with polymer core materials in such a way that they simulate the appearance of known security devices more traditionally used with paper core materials.

### FIELD OF THE INVENTION

The invention relates to security devices, their use, and methods to produce such security devices. Such security devices are typically incorporated into security documents of value, including documents which may be subject to counterfeiting, such as passports, banknotes and other articles.

### BACKGROUND TO THE INVENTION

Bank notes and other security documents frequently incorporate optically variable devices (OVDs) such as diffraction gratings or holographic optical microstructures as security features against copy and counterfeit. The increased use of such devices has been motivated by progress in the fields of computer based desktop publishing and scanning, which render conventional security print technologies, such as intaglio and offset printing, increasingly susceptible to counterfeit. One way to strengthen security documents against counterfeit is to combine security print with optically variable devices whose structures cannot be replicated by scanners, and which can exhibit optically variable effects such as colour changes by diffraction, movement effects, and distinct switches between images.

Holograms are widely used as security features in credit cards as they cannot be reproduced by photographic or photocopying techniques. To enhance the security of holograms and to prevent contact copies being made, a technique was developed for making holograms by a process of demetalization. Demetalized holograms and patches are often used in passports and ID cards to protect photographs and data. The image beneath the hologram is only visible when the document is tilted. Other OVDs include polymer or laminate microstructures in the form of foils that exhibit colour shifts in transmitted light passing through the foil and/or ambient light reflecting from the foil. Tilting the foil results in a visible colour-shift effect due to the laminate microstructure and/or Bragg stacking within the foil. Such devices provide particularly useful surface security features in applications where the substrate to which they are applied is flexible or foldable, such as in banknotes.

Security devices may also take the form of strips or threads which are made from a transparent film provided with a continuous reflective metal layer, vacuum deposited aluminium on polyester film being the commonest example. Banknotes made using such security devices have been in general circulation in many countries for many years. When such security elements are fully embedded in security paper, and the paper is subsequently printed to provide the security document (e.g. a banknote), the thread cannot be discerned readily in reflected light but is immediately apparent as a dark image when the document is viewed in transmitted light. Such threads are effective against counterfeiting by printing or photocopying, since the optically variable effect cannot be simulated accurately, for example by printing a line on the paper.

The composition, size and positioning of security threads may vary depending upon the desired security of the document. Typical security threads are composed of a polymeric film such as polyester, which may be metalized or coloured, and which may include micro-printed lettering denoting a title or message. The lettering can be produced by printing onto the substrate or by de-metalizing a metallic layer on the substrate. Micro-printed threads may be slit to produce either registered lettering with respect to the edge of the thread, or unregistered lettering designed so that the message always appears irrespective of thread slitting. Moreover, the positioning of the thread within the document may be strictly controlled to agreed criteria and may be concurrent with additional security features, such as a watermark. Traditionally, security threads are embedded within security paper in such a way that paper fibres cover both sides of the thread, making it considerably less visible in reflective light, but clearly visible in transmitted light.

In recent times, however, modern counterfeiting techniques have made use of sophisticated colour separation, printing and colour photocopy technology. Thus, it has become common to use a security thread comprising a thin layer of aluminium on a plastic support which is exposed on one side of the paper sheet at intervals along the length of the thread, the region of exposure being referred to as a ‘window’. Again, the positioning of the windows may be controlled to allow registration of the window with respect of the document and other security features such as watermarks.

This latter development has resulted in enhanced security, and windowed paper has been used for banknotes in many countries. A banknote of this type provides added security against counterfeiters as, when viewed in transmitted light, the strip is seen as a dark line and when viewed in reflected light on the appropriate side, the bright shining aluminium portions which are exposed at the windows are readily visible. The aluminium portions may provide further enhanced security if they incorporate holographic or other OVD features. Nonetheless, the reflected light appearance of the exposed aluminium portions of a security device can be simulated to a degree by modern materials and techniques.

Also known in the art is the use of polymer-based films or sheets as an alternative basic substrate for the production of security documents such as bank notes. In some countries such films are used instead of paper-based substrates for bank note production. In comparison to bank notes manufactured on a paper substrate, polymer film bank notes are highly resilient to tearing, wear and abrasion. As such the bank notes have a longer useable lifespan, and thus may remain in circulation for an extended period of time. However, it can be more difficult to incorporate security features and devices into such bank notes. As desired, such features may be printed or deposited upon the surface of the polymer-based films. Alternative techniques involve layering of polymer films for example to produce a laminate structure, wherein security features of devices may be incorporated between layers of the laminate structure.

Thus there is a continuing need for security devices and features for security documents, in order to render the task of document replication more difficult for a counterfeiter.

### SUMMARY OF THE INVENTION

It is one object of the present invention, at least in preferred embodiments, to provide a security feature or device for a security document.

Certain exemplary embodiments provide for a security device for use with a security document, the security device comprising:
a. a security thread
a. a masking layer applied to the security thread to conceal at least a portion of the security thread in reflected light.

Certain other exemplary embodiments provide for a security document comprising:
a. a core material;
b. at least one security device as described herein, applied to one or both sides of the core material.

Certain other exemplary embodiments provide for a method for the production of a security device suitable for use in a security document, the method comprising the steps of:
a. providing a security thread;
b. applying a masking layer to at least a portion of the security thread to conceal the portion in reflected light.

Certain other exemplary embodiments provide for a method for the production of a security document, the method comprising the steps of:
a. providing a security device as described herein;
b. applying the security device to a first side of the core material of the security document;
c. optionally applying a fluorescent ink layer to a side of the core material opposite the first side, in alignment with the security thread; and
d. optionally applying a further masking layer to the core material on a side opposite the first side to at least partially conceal the fluorescent ink layer, if present.

### BRIEF DESCRIPTION OF THE DRAWINGS

FIG. 1 provides a plan view of a sheet of security paper containing a security thread viewed in reflected light (prior art, derived from FIG. 1 of U.S. Pat. No. 6,616,190)

FIG. 2 provides a front view of an example security document incorporating an example security device.

FIG. 3 provides a back view of an example security document incorporating an example security device.

FIG. 4a provides a cross-sectional view of an example security document incorporating an example security device, taken along line A-A′ in FIGS. 2 and 3.

FIG. 4b provides a cross-sectional view of an example security document incorporating an example security device, taken along line B-B′ in FIGS. 2 and 3.

FIG. 5 illustrates an ambient colour shift observed with the security document illustrated in FIG. 4.

FIG. 6 illustrates a transmissive colour shift observed with the security document illustrated in FIG. 4.

FIG. 7 illustrates a fluorescent colour shift observed with the security document illustrated in FIG. 4.

### DEFINITIONS

Adhesive/adhesive layer: refers to a substance optionally formed into a layer that causes adhesion of one layer of a security device and/or a security document to another. The adhesive may comprise any adhesive that is known in the art, but may be selected according the materials being subjected to the adhesion. Such adhesive materials may be selected from, but are not limited to, polyolefins and other well known polymers and co-polymers. Furthermore, the adhesive materials may by curable at room temperature, or may be heat activated.
Core material: refers to any material used to form the main structure or sheet of a security document. The material is typically formed into a sheet or planar member, and may be composed of a substance selected from but not limited to paper, a plastic, a polymer, a resin, a fibrous material or the like. In selected embodiments the core material is of a material suitable for application thereto, either directly or indirectly, of a security device of the types disclosed herein. The security device, or elements thereof, may be applied or attached to the core material in any manner including the use of adhesive materials or layers, such as glues, or by overlaying an adhesive substance, film, varnish or other material over the top of the security device or components thereof. The core material may be smooth or textured, fibrous or of uniform consistency. Moreover, the core material may be rigid or substantially rigid, or flexible, bendable or foldable as require by the security document. The core material may be treated or modified in any way in the production of the final security document. For example, the core material may be printed on, coated, impregnated, or otherwise modified in any other way. Fluorescent ink/fluorescent ink layer: refers to any ink or combination of ink or toner compositions that include a luminescent material that converts at least part of incident energy into emitted radiation with a characteristic signature. Non-limiting examples include materials which exhibit fluorescent and/or phosphorescence. For example, such a fluorescent ink may be used to provide an ultraviolet (UV) fluorescent feature. Such a feature may be applied as an ink, which may be visible or invisible, for example by offset printing and may form an image made up of one to three colours (red, green, blue). The image is detected by exposure of the bank note to a UV light source (typically UVA at 365 nm). The fluorescent ink may be visible on a surface of a security document, or alternatively may be concealed or partially concealed beneath one or more other layers such as a masking layer. In selected embodiments the fluorescent ink may comprise a luminescent material which, when stimulated emits luminescent radiation at first and second wavelengths, the second wavelength being different from said first wavelength; and an optically variable device arranged to control emission of the luminescent radiation from said security device, and which, at a first angle or first range of angles of emission from said security device limits emission of luminescent radiation to a first colour including said first wavelength or a first range of colours including said first wavelength, and at a second angle or second range of angles of emission from said security device, different from said first angle or first range of angles, limits emission of luminescent radiation to a second colour including said second wavelength or a second range of colours including said second wavelength, wherein said second colour or range of colours is different to said first colour or range of colours. Example fluorescent inks and corresponding features are disclosed for example in patent application number, which is incorporated herein by reference.
Masking layer: refers to any layer used in a security device as described herein to conceal or partially conceal a security thread from view in reflected light. The masking layer may be sufficiently opaque such that the security thread cannot be seen through the layer even in bright reflected light because at least 99% of the light incident upon the layer is substantially unable to penetrate the layer. A masking layer may also be less opaque such that a small percentage (e.g. 1 to 30%) of the light incident upon the layer may be transmitted through the layer, such that the security thread beneath may be slightly visible upon visual inspection in bright reflected light conditions. Any masking layer may cover the security thread, or partially cover the security thread such that the security thread is entirely visible in reflected light conditions at those portions not covered by the masking layer. The regions of the security thread not covered by the masking layer are referred to as ‘windows’ through which the security thread may be seen. The degree of opacity of the masking layer may determine the amount of light incident to the layer that passes through the layer by light transmission. In selected embodiments it may be desired for the masking layer to exhibit a degree of translucency such that an amount (e.g. 1-50%) of light incident upon the masking layer may be transmitted through each masking layer. In this way, a person holding a bank note or other security document up to a source of light may be able to observe the presence of a security thread forming part of a security device of the bank note without significant difficulty, because a degree of light transmission may occur through any masking layer immediately adjacent the security thread.
Opacifier material: refers to any substance used to form the masking layer as part of a security device as described herein. The material, once applied in the form of a layer of from between 0.001 and 10,000 microns in thickness, provides a degree of opacity such that between 0 and 90% of light incident upon the layer is transmitted through the layer. Such opacifier materials include, but are not limited to, any form of at least partially opaque ink or toner compositions, or any form of emulsion or suspension composition wherein the suspended component contributes at least in part to the opaque or translucent properties of the material. For example, typical opacifier materials may include metal oxides such as titanium dioxide dispersed within a binder or carrier material. In selected embodiments the opacifier material, when applied as a layer, has an optical density of from 0.1 to 5.
Reflected light: refers to light incident upon a surface and subsequently bounced by that surface such that the reflected light is visible to the eye. The degree of light reflection may vary according to the surface, and the degree of light that is not reflected by the surface because it is scattered by, diffracted by, or transmitted through the surface and the material of the substrate.
Polymer core material: refers to any polymer or polymer-like substance suitable to form a core material in the form of a sheet-like configuration to be formed or cut into a size suitable for use as in security documents. The polymer core material may be a substantially uniform sheet of polymer material, or may take the form of a laminate structure with layers or polymer film adhered together for structural integrity, such as disclosed for example in international patent publication WO83/00659 published Mar. 3, 1983, which is incorporated herein by reference.
Security document: refers to any document of importance or value. In selected embodiments, a security document may include features or devices intended to show that the document is a genuine and legitimate document, and not a non-genuine or illegitimate copy of such a document. For example, such security documents may include security features such as those disclosed herein. Such security document may include, but are not limited to, identification documents such as passports, citizenship or residency documents, drivers' licenses, bank notes, cheques, credit cards, bank cards, and other documents of monetary value.
Security device or feature: refers to any device or feature that may be added to a security document for the purposes of making that security document more difficult to copy or replicate.
Security thread: refers to any elongate strip or thread applied directly or indirectly to or incorporated into a core material of a security document for the purposes of providing a security device or feature to the document, or for the purposes of providing a component of a security device or feature for the document. Security threads typically include a structure or materials suitable to make the security thread conspicuous in transmitted and/or reflected light. For example, a security thread may include a metal or metalized layer to make the security thread conspicuous in transmitted light. Alternatively, for example, a security thread may include an optically variable feature or device beste observed in transmitted or reflected light. Traditionally, security threads are incorporated for example into bank notes comprising a paper core material or substrate, and the thread may be concealed from view in reflective light by the core material, or alternatively the thread may be partially visible as it emerges in windows in the core material, or by virtue of its threading into the core material. In accordance with the teachings herein, where the core material is a polymer core material, the security thread may also take the form of an elongate strip adhered to the polymer core material (or an intermediate layer), or may be laminated between the polymer core material and one or more other layers.
Transmitted light: refers to light that is incident upon a surface, layer or multiple layers, of which a portion of the light is able to pass through and/or interact in some way with the surface or layer or layers by transmission. Light may be transmitted through a layer or layers by virtue of the layer or layers not being entirely opaque, but instead permitting at least a portion (e.g. 0-99%) of the incident light to be transmitted through the layer or layers in view of the layer or layers exhibiting at least some degree of translucency.
Window: refers to a region or portion of a security device in which a component of a security device, such as a security thread, is exposed for visual inspection, because there is little or no translucent or opaque material to obscure the view of the exposed portions. A window may be present even if there are transparent or translucent layers, for example of film, to cover the security device or components thereof, because the exposed portions of the security thread are still visible, at least in part, through the film. In further selected embodiments as disclosed herein ‘window’ refers to one or more portions of a security device as disclosed herein in which a masking layer does not extend across all of the surface of a security thread, such that portions of the security thread are exposed for visual inspection in reflective light.

### DETAILED DESCRIPTION OF THE INVENTION

Counterfeit security documents are a continuing concern. Techniques for the production of counterfeit security documents are becoming increasingly sophisticated. For this reason, the inventors have endeavoured to generate security devices that are exceptionally difficult to copy by counterfeit methods. Moreover, the inventors have endeavoured to develop, at least in preferred embodiments, new security devices for use with security documents that emulate the appearance of more traditional security devices. In this way the devices may appear familiar to an owner or user of a security document, even though they are produced by alternative techniques, and even though they may comprise an alternative structure to previous devices.

In selected embodiments, the security devices are suitable for any type of security document, and the devices are suitable for application to security documents based upon any type of core material including but not limited to paper and polymer core materials. For example, in the case of bank notes, it is well known that such documents may be produced using paper or polymer-based core materials. Most central banks still direct the production of bank notes based upon paper core materials. However a few, including the Australian central bank, direct the manufacture of bank notes based upon a polymer core material. As discussed, such bank notes present distinct advantages over paper bank notes. For example, relative to paper bank notes, polymer bank notes are exceptionally abrasion and tear resistant. Moreover, they are highly resistant to degradation or disintegration in water or other solvents. As a result of their robustness, polymer bank notes may remain in circulation for an average of several years. This lifespan is much higher than for paper bank notes, which must often be withdrawn from circulation within a matter of few years from their date of production due to wear and tear. Therefore, although polymer bank notes are at times more expensive to manufacture compared to paper bank notes, polymer bank notes require replacement from circulation on a far less frequent basis.

However, polymer bank notes (and other security documents based upon polymer core materials) are less amenable to incorporation of some types of security devices. For example, security threads have been incorporated into paper bank notes for many years. The threads are relatively easy to incorporate and retain in position due to the fibrous nature of the paper core material, and the ease of combining layers of paper core material together. Depending on the manufacturing process it can be more difficult to incorporate a thread into a polymer core material. In particular, polymer core materials are not generally suitable for incorporation of security threads as an integral feature. The present invention, at least in selected embodiments, presents an advantage because the invention provides security devices and methods that permit a security device comprising a security thread that has the appearance of being incorporated as an integral feature of the core material of a security document, even though the security thread is in fact applied by layering to a surface of the core material. In some embodiments the security thread (when forming part of a security document of the present invention) may have the appearance of being embedded within the material of the polymer core material in a similar manner to security threads used in paper security documents, such that the security thread is visible within the document in transmissive but not reflective light. In further embodiments the security thread may form part of a security device such that it appears to be interwoven with the polymer core material of the security document (for example with windows so that portions of the security thread are visible in reflective light) even though the security thread is in fact layered upon the polymer core material.

Thus, in selected embodiments there is provided a security device for use with a security document, the security device comprising:
a. a security thread
b. a masking layer applied to the security thread to conceal at least a portion (1-100%) of the security thread in reflected light.

The security thread may take any form that is known in the art. For example, the security thread may comprise a metallic reflective layer deposited on a polymer, and/or may incorporate optically variable features including but not limited to holograms or optically variable foils.

The masking layer may cover the security thread entirely, such that the security thread is concealed from view in reflected light. The masking layer may be applied to one or both sides of the security thread. If the masking layer contacts just one side of the security thread then the other side may be concealed from view in reflective light when the security device is applied to the core material, such that the security thread is sandwiched between the masking layer and the core material to give the appearance of being embedded in the core material at least when viewed in transmissive light.

In alternative embodiments, the masking layer may be absent from at least one portion of the security thread. In this way the security device may include one or more windows in the masking layer through which the security thread can be seen when reflected light is incident upon the surface of the device. For example, the security thread may have a metallic or optically variable appearance (especially if the security thread is manufactured for example to include a hologram or optically variable foil). Thus it may be desired to view the metallic or optically variable features of the security thread in reflected light. Importantly, by providing windows in the masking layer the security thread may have the appearance of being an integral feature of the core material. It is known in the art to provide a security device comprising a security thread for application to or incorporation into a paper core material, wherein the core material and/or the thread are cut or split so that the security thread may be intertwined or interwoven into the paper core material. This can be much more difficult to achieve using a polymer core material depending on the polymer core manufacturing process. Therefore the security devices and methods of the present invention, particularly those comprising windows in the masking layer, afford an opportunity to manufacture security devices for application to a polymer core material wherein the security devices at least appear to be interwoven or intertwined, or embedded into the core material, even though they are in fact layered onto the core material as herein described.

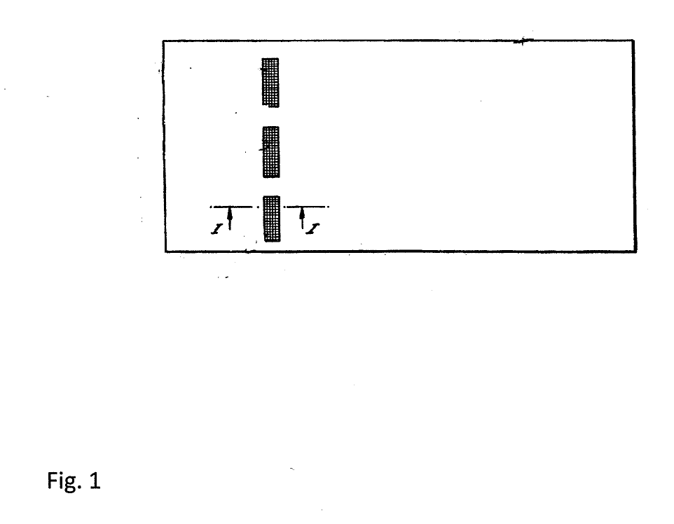

For example, in selected embodiments the security device may include a plurality of windows in the masking layer that are of a similar or identical size, and which are evenly distributed along the length of the security device. In this way the security thread, when applied to a core material such as a polymer core material for a bank note, may have the appearance of having regularly exposed portions of the security thread, as may be observed for example in FIG. 1, which is derived from U.S. Pat. No. 6,616,190 issued Sep. 9, 2003, is incorporated herein by reference.

In any of the embodiments described herein the masking layer typically comprises an opacifier material of sufficient opacity and thickness to conceal at least a portion of the security thread at least in reflected light. Moreover, in the production of the security device the masking layer may be applied to the security thread either before the security device is affixed to the core material of the security document. Alternatively, the masking layer may be applied to the security thread after the security thread is affixed to the core material. As required, further layers may be added to the security device and/or to the core material. For example adhesive layers may be applied to the core material and/or the security thread and/or the masking layer to facilitate adhesion of the layers to one another. Further layers that may be present include thin film layers applied between the other layers, for example between the masking layer and the security thread. Alternatively, a thin film layer may be applied as a final layer over the masking layer. Such thin film layers may assist in adhesion of the layers together or may contribute to the overall structural integrity of the security device.

The masking layer may be formed in any manner, either before or after the security device is applied to a core material. For example, opacifier material may be formed into a layer upon the security thread and/or core material by deposition of a solid or liquid precursor material upon at least a portion of the security thread. For example, a liquid or solid precursor material sprayed or, printed by techniques such as gravure, or otherwise directed in particulate form towards the security thread and/or the core material such that the liquid or solid particles of the precursor material impact the security thread and/or the core material to form a layer thereupon. Optionally, the layer may be thickened by repeated passes of a jet or nozzle (for spraying the precursor material) towards the security thread/core material.

Alternatively, the masking layer may be formed by forming the masking layer prior to its application to a security thread or core material. For example the masking layer may be cut from a pre-formed sheet of opacifier material formed by any method. Optionally, the opacifer material may be applied (e.g. sprayed, painted etc.) onto a thin film in a desired pattern, such that the thin film provides integrity to the masking layer. Alternatively, the masking layer may be a thin film. As required, the thin film may further comprise an adhesive backing or layer on a side opposite the opacifer material, to facilitate application of the masking layer to the security thread and/or the core material of the security document in a ‘peel-and-stick’ manner. In this way the thin film is sandwiched between the security thread and the opacifier material where present.

As previously discussed, the opacifier material may absent from at least one portion of the masking layer, thereby to provide at least one window in the masking layer through which the security thread is visible in reflected light. The same applies if the masking layer is applied to a thin film, or comprise thin film. The masking layer may include one or more portions where the opacifier material is absent such that the thin film is visible beneath. In selected embodiments the thin film is translucent or transparent, at least over the windowed portions of the masking layer, such that light incident upon each window passes easily though the thin film, reflects off the security thread beneath, and the reflected light is passed back through the thin film to the user's eye. In this way, the presence of the thin film may, at least in selected embodiments, have minimum interference with a person's ability to view and perceive the security thread located beneath the masking layer and thin film.

Certain other exemplary embodiments encompass a security document comprising: any core material; and at least one of any security device as herein described. For example, certain embodiments may encompass a security document with one or more security devices on each side of the core material, each optionally including a security thread visible through windows in the masking material.

If required, the security device may be adhered to a first side of the polymer core material by an adhesive layer to assist in the binding of the core material and the security device to one another. Optionally, the security document may further include a layer of opacifier material on a side of the core material opposite to the first side, thereby to assist in concealment of the core material and/or a portion of the security thread in visible light. In effect, this will provide two layers of opacifier material over at least some portions of the security document, further increasing the opacity of the security document (or at least regions thereof) to transmissive light.

The security document may comprise a security device that includes one or more windows in the masking layer through which the security thread is visible from a first side of the security document in reflective light. The layer of opacifer material on a side of the core material opposite to the first side (if present) may if required be thinner over regions of the core material aligned with said one or more windows, for at least partial transmission of light incident to the one or more windows through the document. Thus, opacifer material may be present or absent on a side of the security document opposite to the side comprising the security device. This may give rise to a range of desired effects for transmissive light incident to the security thread in the windows of the masking layer, with the degree of light transmission effecting the visual appearance of the security thread when held up to the light.

In further exemplary embodiments the security document may further comprise a layer of fluorescent ink or other fluorescent material on a side of the core material opposite the first side, at least substantially in alignment with the security thread on the first side. The presence of the layer of fluorescent ink may cause desirable effects to the reflected and transmitted light incident upon the security device. For example, the layer of fluorescent ink may, with ultraviolet (UV) light incident upon the layer, be caused to emit fluorescent light, and this property may in turn alter the visual affect of light passing back through the security thread, especially if the security thread includes an optically variable device such as an optically variable foil. For example, the emitted fluorescent light may be caused to undergo a colour shift by the optically variable device that would not normally be seen under normal ambient light conditions. Such embodiments will be illustrated with reference to the Figures (see below) as well as patent application ______, filed ______, which is incorporated herein by reference.

In further selected embodiments the core material of the security document comprises a polymer material. Any polymer material may be used that is amenable for formation into sheets. Preferably, the polymer material has properties of strength or resilience such that the sheets, once formed, at substantially resistant to tearing for example by hand.

Still further exemplary embodiments provide for a method for the production of a security device suitable for use in a security document, the method comprising the steps of:
a. providing a security thread;
b. applying a masking layer to at least a portion of the security thread to conceal the portion in reflected light.

If required in step b. at least one other portion of the security thread may remain visible in reflected light because it is not concealed by the masking layer. In this way, the masking layer may be applied or be formed on the security thread such that the security thread remains visible through one or more windows in the masking layer.

Step b. of applying a masking layer may be performed in any suitable manner. In selected embodiments the step may comprise:
i. providing a masking layer in the form of a thin film; and
ii. adhering the thin film to the security thread.

In further selected embodiments there is provided a method for the production of a security document, the method comprising the steps of:
a. providing a security device as described herein;
b. applying the security device to a first side of the core material of the security document; and
c. optionally applying a further masking layer to the core material on a side opposite the first side.

The invention will be further explained and described with reference to a series of Figures. These Figures merely disclose selected or preferred embodiments of the invention, and are not in any way intended to limit the scope of the appended claims. Although the Figures illustrate a security document in the form of a bank note comprising a polymer core material, this is for illustrative purposes only. The security device and the features shown may be applied to any security document comprising any core material as required.

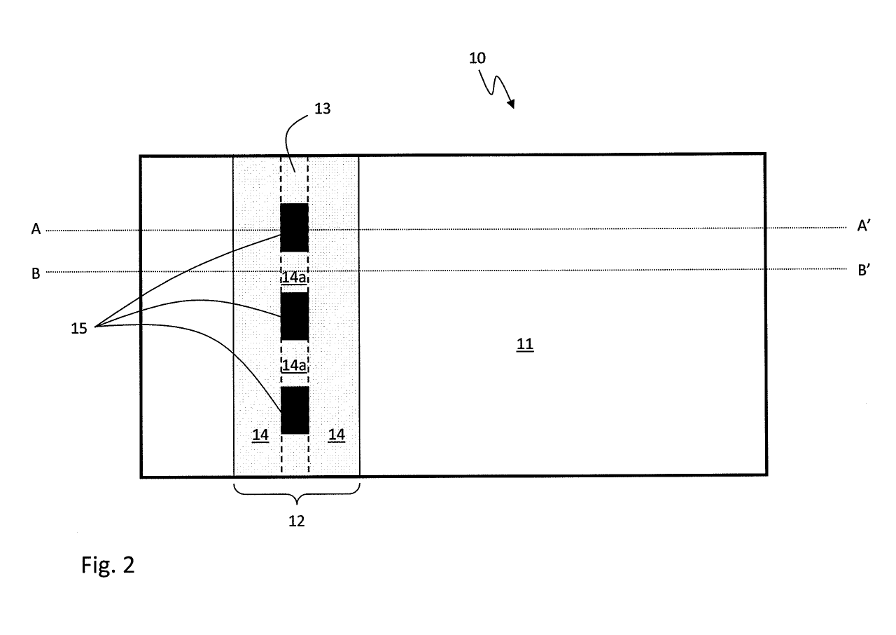

FIG. 2 provides a front or plan view of a bank note shown generally at 10, which is comprised at least in part of a main polymer core material 11. The bank note 10 includes a region or band 12 that incorporates an example embodiment of a security device. The device includes a security thread 13 comprising an optically variable foil running generally across the width of the bank note in a direction at least substantially perpendicular to the longitudinal edges of the bank note. The majority of the security thread 13 is concealed from view because it is located beneath masking layer 14, which extends the width of the bank note and each side of the security thread 13. Furthermore, portions of the security thread 13 are covered over by masking layer 14 at regions 14a of the device. However, in the embodiment illustrated in FIG. 2 the masking layer 14 does not cover the entire surface of security thread 13: regions 13a of the security thread 13 remain visible to the eye in reflected light due to the absence of the opacifier material of the masking layer at windows 15. Therefore, security thread 13 runs beneath the regions 14a of the masking layer, as denoted by the dashed lines.

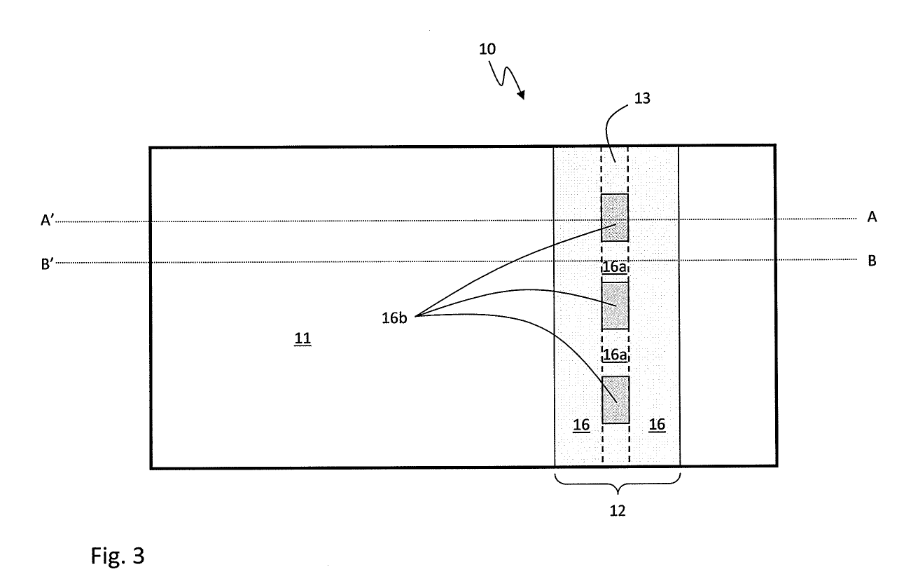

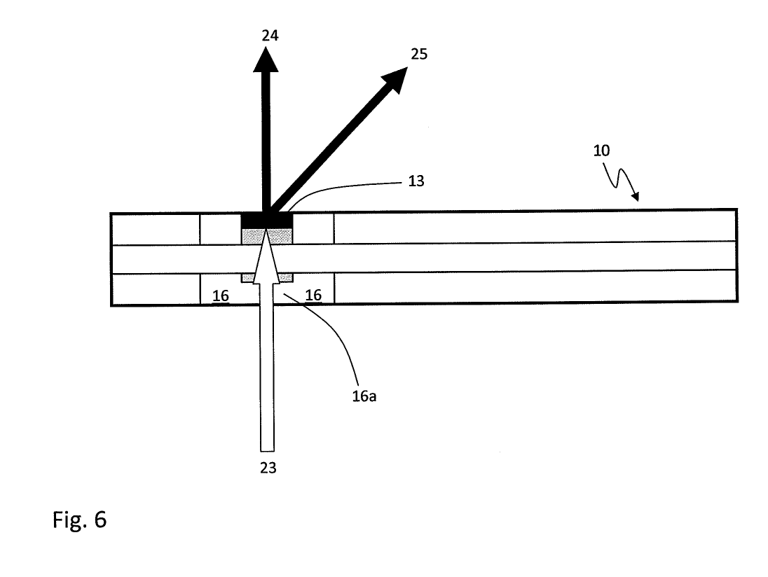

FIG. 3 illustrates the same bank note shown in FIG. 2, from a rear view to observe the opposite side. Effectively, the bank note has been flipped horizontally over. The core material 11 is shown, this time from an opposite site to the core material 11 shown in FIG. 1, with the general position of the security thread affixed to the opposite side of the core material shown again by way of dashed lines. Furthermore, a second masking layer 16 has been applied to the core material in a general pattern or arrangement that matches or opposes the masking layer 14 shown in FIG. 2. The masking layer 16 includes regions 16a of full thickness with regard to the opacifier material of the masking layer. However, in regions 16b of the masking layer 16 the opacifier material is thinner (although in selected embodiments it may be absent) and overlays a band of fluorescent ink (not shown) printed upon the core material in line with, but on an opposite side of the core material to, the security thread. Regions 16b are aligned with windows 15 on the opposite side of the bank note (see FIG. 2), such that a portion of light incident upon the rear side of the bank note may be transmitted through the regions 16b, through the core material 11 for interaction with the optically variable foil of the security thread 13 shown in regions 13a in FIG. 2. The transmission of light in this manner is explained in more detail below with reference to FIG. 6.

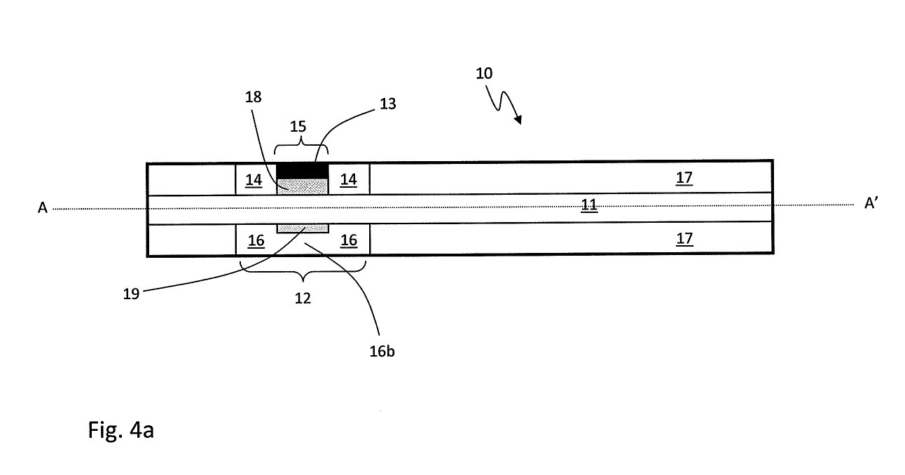

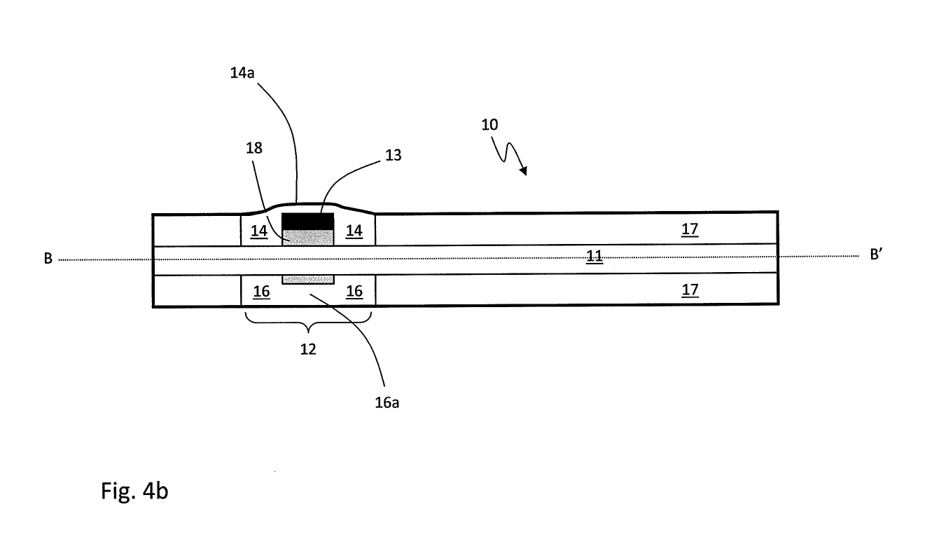

Lines A-A′ and B-B′ as shown in FIGS. 2 and 3 are lines of cross section illustrated in subsequent Figures. FIG. 4a illustrates a cross section through bank note 10 at lines A-A′. Polymer core 11 is shown as a continuous, uninterrupted sheet of polymer material with various device components and layers applied to each side of the core material. The thickness of the various components and layers are exaggerated compared to usual dimensions for illustrative purposes only. As per FIG. 2, the region of the bank note that comprises the security device is shown at 12. The other regions of the bank note include an opacifier material 17 of a type known in the art to increase the general opacity of the bank note. The security thread 13 comprising optically variable foil is also shown with an adhesive layer 18 to secure or affix the security thread to the core material 11 by adhesion. Directly across the core material 11 from security thread 13 is fluorescent ink layer 19. The fluorescent ink layer may take any size, shape or form, but in the presently illustrated embodiment is printed directly to the core material a few millimeters wide across the width of the bank note, so that it aligned with the security thread adhered to the opposite side. Masking layers 14 and 16 correspond to the masking layers illustrated in FIGS. 2 and 3 respectively. Note that masking layer 14 is present either side of security thread 13 but does not cover the security thread due to the presence of window 15. In contrast the masking layer 16 on an opposite side of the core material 11 does cover fluorescent ink layer 19. The region of the masking layer 16 is, however, thinner over the fluorescent ink layer compared to regions either side, for the reasons discussed above.

FIG. 4b provides another cross-sectional view of bank note 10, this time along lines B-B′ as shown in FIGS. 2 and 3. The components and features of the bank note at this cross-section position are virtually identical to FIG. 4a with important exceptions. These relate to the configuration of masking layers 14 and 16 on each side of the core material. It will be noted that a portion 14a of masking layer 14 extends over security thread 13 to at least substantially obscure the security thread from view in reflected light. Likewise, a portion 16b of masking layer 16 extends over fluorescent ink layer 19, again to at least substantially obscure the fluorescent ink layer from view. Although the thickness of the layers shown in FIGS. 4a and 4b is exaggerated, it will be appreciated that in a finished bank note the layers may be too thin for a user of the bank note to detect how many layers are present. Thus the bank note, at least in selected embodiments, may have the appearance of comprising a security thread that is integrated (e.g. in accordance with standard techniques with paper core materials) directly into the core material of the bank note, even though the bank note comprises a polymer core material.

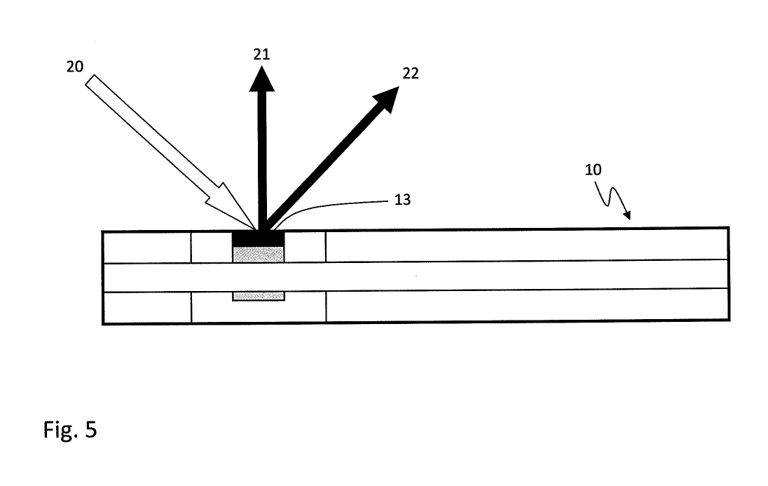

FIGS. 5, 6, and 7 illustrate the optical effect of light incident upon the bank note 10, and in particular the security device in region 12 of the bank note. Each of FIGS. 5, 6, and 7 provide the same cross-section A-A′ as shown in FIG. 4a.

Turning first to FIG. 5 there is shown the effects of ambient light reflecting off the optically variable film from a front side of the bank note. The ambient light 20 is directed towards security thread 13, which comprises optically variable foil. A user observing the bank note to receive light 21 may observe gold-coloured reflected light. However, if the bank note is tilted (or if the user moves position) such that the reflected light is received at position 22 then the user may observe magenta-coloured reflected light. Thus a colour-shift of the reflected light may be observed. Alternatively, a gold-to-green colour-shift may be observed if some black text is added behind the optically variable foil layer. The precise nature of the colour-shift will depend upon the nature or type of optically variable foil (or other optically variable device) used, upon the positioning of the user as well as the user's perception of colour. The colour-shifts described herein are merely for illustrative purposes only.

In contrast to FIG. 5, FIG. 6 illustrates an example of a colour-shift effect of light transmitted through the bank note 10. Ambient light 23 incident upon a rear side of bank note 10 may pass through the bank note as shown in FIG. 6 by virtue of the relative translucency of the bank note at the region of the security thread. Thus, at least a portion of ambient light 23 passes through region 16b of masking layer 16, through fluorescent ink layer 19, through adjacent core material 11, and through adhesive layer 18 such that the transmitted light becomes incident upon and interacts with the optically variable foil of security thread 13. By virtue of the nature of the transmitted light, the construction of the optically variable foil, and the angle of incidence of the light upon the foil, an alternative colour-shift may be observed by a user from the front side of the bank note 10. As shown, light passing directly or almost directly through the security thread at position 24 may be cyan in colour, whereas light diffracted by the optically variable foil of the security thread at position 25 may be magenta in colour. Thus a user of the bank note observing the transmitted light will observe a cyan-to-magenta colour shift as the bank note is tilted (or as the user moves position). Again, the precise colour shift will depend upon the optically variable device used, upon the position of the user, and also upon the user's perception of colour. Thus, the colour-shift described for transmitted light is for illustrative purposes only. If required, the masking layer 16 on the reverse side of the bank note 10, and in particular the thickness and/or density of region 16b of the masking layer 16, may be adjusted to increase or descrease the amount of light 23 that can be transmitted through the security thread.

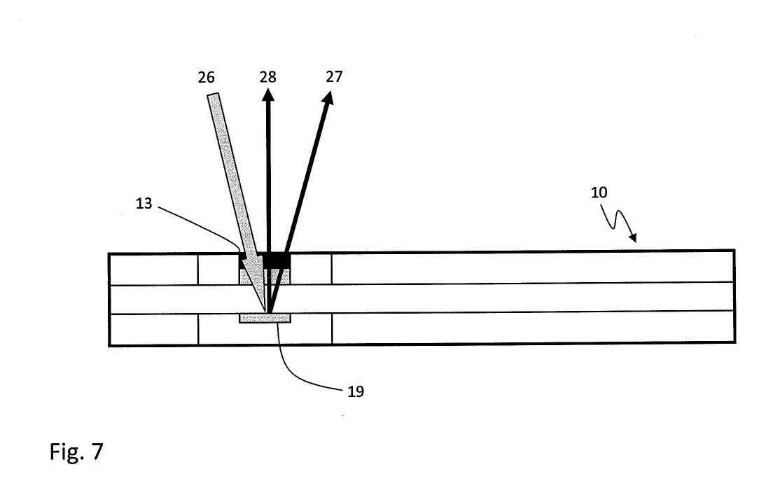

Turning now to FIG. 7, the same bank note 10 is illustrated with cross-section A-A′. However, FIG. 7 illustrates the colour-shift observed by reflection of fluorescent light. For example, if ultraviolet light 26 is directed towards security thread 13, then at least a portion of the UV light 26 may be transmitted initially through the optically variable foil of the security thread, as well as the adjacent core material 11. Subsequently, at least a portion of the transmitted portion of the UV light 26 may be reflected by the fluorescent ink layer 19, such that the reflection portion of the emitted fluorescent light is transmitted back through the core material 11 for interaction with the optically variable foil of the security thread 13. As shown, fluorescent light passing directly or almost directly through the security thread at position 27 may be red in colour, whereas light diffracted by the optically variable foil of the security thread at position 28 may be green in colour. Thus a user of the bank note observing the fluorescent light emanating from the optically variable foil will observe a green-to-red colour shift as the bank note is tilted (or as the user moves position). Again, the precise colour shift will depend upon the optically variable device used, upon the position of the user, and also upon the user's perception of colour. Thus, the colour-shift described for reflected fluorescent light is for illustrative purposes only.

Whilst various embodiments of security devices, security documents, as well as methods for their production and use, are described and illustrated herein, the scope of the appended claims is not limited to such embodiments, and the invention encompasses further embodiments readily obtainable in view the teachings presented herein.

1. A security device for use with a security document, the security device comprising:
a. a security thread
b. a masking layer applied to the security thread to conceal at least a portion of the security thread in reflected light.

2. The security device of claim 1, wherein the masking layer is absent from at least one other portion of the security thread, thereby to provide at least one window in the masking layer through which the security thread is visible in reflected light.

3. The security device of claim 1, wherein the device includes a plurality of windows of similar size spaced equally along the security thread.

4. The security device of claim 1, wherein the masking layer comprises an opacifier material to conceal at least a portion (0.1% to 100%) of the security thread in reflected light.

5. The security device of claim 4, wherein the opacifier material is formed by deposition of a solid or liquid precursor material upon at least a portion of the security thread, or a layer covering the security thread.

6. The security device of claim 4, wherein the masking layer is formed by direct or indirect adhesion of a layer of the opacifier material upon at least a portion of the security thread.

7. The security device of claim 6, wherein the opacifier material contacts a thin film adhered to the security thread, such that the thin film is sandwiched between the security thread and the opacifier material where present.

8. The security device of claim 7, wherein the opacifier material is absent from at least one other portion of the thin film, thereby to provide at least one window in the masking layer through which the security thread is visible in reflected light through the thin film.

9. The security device of claim 4, wherein the opacifier material comprises a metal oxide.

10. The security device of claim 1, wherein the security thread comprises an optically variable device such as a hologram or an optically variable foil.

11. The security device of claim 1, further comprising a fluorescent ink layer to convert UV light into visible or near infrared light.

12. A security document comprising:
a. a core material;
b. at least one security device according to claim 1, applied to one or both sides of the core material.

13. The security document of claim 12, wherein the document includes two security devices, each applied to opposite sides of the core material.

14. The security document of claim 12, wherein a security device is adhered to a first side of the core material by an adhesive layer.

15. The security document of claim 12, wherein the document further includes:
c. a layer of opacifier material on a side of the core material opposite to the first side thereby to assist in concealment of the core material and/or a portion of the security thread in reflected light.

16. The security document of claim 15, wherein the security device includes one or more windows in the masking layer through which the security thread is visible from the first side in reflective light, and the layer of opacifer material on a side of the core material opposite to the first side is thinner over regions of the core material aligned with said one or more windows, for at least partial transmission of light incident to said one or more windows through said security document.

17. The security document of claim 12, further comprising a fluorescent ink layer on a side of the core material opposite the first side, at least substantially in alignment with said security thread on said first side.

18. The security document of claim 17, wherein the security thread comprises an optically variable device, such that light incident upon the fluorescent ink is reflected as a fluorescence emission, which passes through the optically variable device thereby to cause a colour shift in the fluorescence emission as perceived by a user of the security document.

19. The security document of claim 12, wherein the core material comprises a polymer material.

20. A method for the production of a security device suitable for use on a security document, the method comprising the steps of:
a. providing a security thread;
b. applying a masking layer to at least a portion of the security thread to conceal at least the portion in reflected light.

21. The method of claim 20, wherein in step b. at least one other portion of the security thread is not concealed by the masking layer, thereby to provide windows in the masking layer through which the security thread is visible in reflected light.

22. The method of claim 20, wherein step b. comprises:
i. providing the masking layer in the form of a thin film; and
ii. adhering the thin film to the security thread.

23. A method for the production of a security document, the method comprising the steps of:
a. providing the security device of claim 1;
b. applying the security device to a first side of the core material of the security document;
c. optionally applying a fluorescent ink layer to a side of the core material opposite the first side, in alignment with the security thread; and
d. optionally applying a further masking layer to the core material on a side opposite the first side to at least partially conceal the fluorescent ink layer, if present.
